(19) United States
(12) Patent Application Publication
(10) Pub. No.: US 2022/0288828 A1
(43) Pub. Date: Sep. 15, 2022

(54) THERMOPLASTIC ARTICLE FORMING AND ANNEALING APPARATUS

(71) Applicant: Nexe Innovations Inc., Surrey (CA)

(72) Inventors: DARREN JOSEPH FOOTZ, Surrey (CA); ZACHARY M. HUDSON, Surrey (CA)

(21) Appl. No.: 17/694,342

(22) Filed: Mar. 14, 2022

Related U.S. Application Data
(60) Provisional application No. 63/165,523, filed on Mar. 24, 2021.
(60) Provisional application No. 63/160,581, filed on Mar. 12, 2021.

(51) Int. Cl. B29C 45/72; B29C 71/02

(52) U.S. Cl. CPC B29C 45/7207; B29C 71/02; B29C 2071/022; B29L 2031/7174

(57) ABSTRACT

A system and method for molding, forming, and annealing an article of manufacture using a series of molds are disclosed. Such systems and methods may melt degradable thermoplastic materials that are then injected into a first mold to form an article of manufacture. This article may then be moved to a second mold where the formed article is annealed. The second mold may be heated based on operation of a heating element that heats the annealing mold. This annealing process may condition materials in the formed article to enhance properties of the article. For example, annealing may improve thermal resistance of the article. Systems of the present disclosure may employ two molds, one mold that forms articles and a second mold that anneals articles to facilitate a continuous production beverage pods using environmentally friendly materials.

### CROSS-REFERENCE TO RELATED APPLICATION

The present application claims the priority benefit of U.S. provisional application No. 63/165,523, filed Mar. 24, 2021 and U.S. provisional application No. 63/160,581 filed Mar. 12, 2021 the disclosures of which is incorporated herein by reference.

### BACKGROUND OF THE INVENTION

### Field of the Invention

The present disclosure relates to a beverage cartridge such as, for example, a compostable beverage cartridge for single-serve use. The present disclosure further relates to methods of manufacture and uses thereof including forming and treating thermoplastic articles, such as beverage brewing pods.

### Description of the Related Art

Single-serve beverage cartridges have become a dominant method for serving beverages, especially hot beverages, in a variety of settings such as homes, offices, waiting rooms, hotel rooms and lobbies, and other places where people consume beverages. The rapid growth of single-serve beverage cartridges is driven by consumer preference for convenient, quickly prepared beverages in single-portion quantities, in a variety of flavors, beverage types (coffee, espresso, decaffeinated coffee, tea, decaffeinated tea, cider, hot cocoa/chocolate, bone broth, and even alcoholic beverages, such as, for example, Irish Coffee, Hot Toddy, Hot Buttered Rum, etc.). Even within a beverage type, such as coffee, there may be a plurality of roasts and associated roasters, flavor profiles, flavor additives, caffeine strengths, location or locations of origin, etc.

The convenience and variety of single serving beverage cartridges allows and encourages consumers to prepare and consume a plurality of beverages throughout the day. This pattern of consumption causes the rapid accumulation of used beverage cartridges wherever they are consumed. Due to the nature of single-serving beverage cartridges, a considerable amount of packaging waste is produced per beverage consumed compared to preparing beverages by traditional means, such as, for example, preparing a plurality of servings at once using bulk ingredients. Packaging waste, according to the United States Environmental Protection Agency (EPA), defines containers and packaging as products that are assumed to be discarded the same year the products they contain are purchased. The EPA further estimates that the majority of the solid waste are packaging products. Packaging waste contributes significantly to global pollution, the introduction of contaminants into the natural environment that cause adverse change, which poses a health risk many forms of life, including humans, other animals, plants, fungi, etc.

Single-serve beverage cartridges typically comprise several components made of various materials. The typical components of a single-serve beverage cartridge include, at least, a container, typically made from plastic such as polyethylene, a filter, typically made from plant fiber such as abacá fibers or other natural and synthetic fibers, and a container lid, typically made from food-grade aluminum foil, which is also commonly printed upon to include product labelling. Some beverage cartridges do not contain a filter, typically because the beverage material is readily soluble in hot water (such as, for example, hot cocoa). The container will usually comprise an opening on the top of the container, and a hollow cavity within which and across which a filter may be disposed. The container may also comprise an opening at on the bottom container. After the filter and beverage material are inserted into the container, the lid is then typically sealed over the container opening or openings. The sealed lid typically provides an airtight seal, preventing the exchange of gases between the environment and the interior of the container, thus preventing oxidation and/or spoilage of the beverage material. In beverage cartridges that include a filter, the filter may separate the container into two chambers: a first chamber occupying the space within the container between the filter and the opening of the container, the first chamber for holding dry beverage ingredients such as, but not limited to, coffee, tea, or cocoa, for a single beverage serving; and (ii) a second chamber occupying the space within the container between the filter and the base of the container, the second chamber being on the opposite side of the filter to the first chamber. The purpose of the second chamber is typically to provide a space in which a fluid extractor of a beverage brewing device may be inserted into the bottom of the container, entering the second chamber and allowing the extraction of fluid from the cartridge without the fluid extractor entering the first chamber, such that fluid flows through the beverage material and the filter before exiting the cartridge via the fluid extractor. However, the presence of the second chamber may significantly reduce the space within the container that can be occupied by beverage medium. This may be problematic as the total amount of beverage material disposed within the container may significantly contribute to the final concentration of the beverage, typically measured in Total Dissolved Solids (TDS). It may be advantageous to minimize the volume of the second chamber in order to maximize the volume on the third chamber, thereby maximizing the total volume available for beverage material. However, the fluid extractor is typically comprised of a sharp, hollow needle-like piercing element designed to easily pierce through the bottom of the container, such that if the second chamber is reduced in size, the fluid extractor may penetrate or damage the filter, allowing the beverage material to exit the first chamber, and ultimately exit the cartridge via the fluid extractor. Thus, in the event the fluid extractor penetrates or damages the filter, the beverage material may be transported into the final beverage, which may be undesirable to consumers (such as, for example, the presences of coffee grounds in a prepared cup of coffee) and may potentially damage the beverage brewing machine (for example, by way of clogging the fluid extractor with beverage material).

The cover is disposed over the opening of the container (which may be, for example, over the top of the container, and/or bottom of the container), and keeps the dry beverage ingredients within the container, as well as providing an airtight seal to prevent the oxidation and other types of degradation of the container's contents. In practice, a single-serving beverage cartridge is placed into a compartment of a brewing machine. The machine is activated such that a fluid injector penetrates the cover of the cartridge and a fluid extractor penetrates the base of the cartridge (which may also be a cover). The fluid injector injects a brewing medium (e.g., hot water) into the first chamber for extracting beverage components from the ingredients. The brewing medium containing the extracted beverage components percolates through the filter and into the second chamber. The brewing medium containing the extracted flavors are then extracted by the fluid extractor and finally dispensed as a drinkable beverage.

Currently, the container of a beverage cartridge for single-serve use is typically made from petroleum-based plastic materials which are neither biodegradable nor compostable. In some cases, the container may be made of petroleum biodegradable materials, such as Polybutylene adipate terephthalate (PBAT). Biodegradation is the decay of organic substances, such as dead plant matter, which are allowed to decompose to the point that various waste products provide nutrients to soil. Biodegradation can be aerobic and/or anerobic, depending on the environment. Aerobic biodegradation is the decomposition of organic matter by microbes that require oxygen to process the organic matter. The oxygen from the air diffuses into the moisture that permeates the organic matter, allowing it to be taken up by the microbes. Anerobic biodegradation is the decomposition of organic matter by microbes that do not require oxygen to process the organic matter. To be anerobic, the system must be sealed from the air, such as with a plastic barrier. Anerobic compositing produces an acidic environment to digest the organic material. A portion of the organic matter may additionally be converted to vermicast, or castings from worms or other animals.

The cover of a beverage pod is typically made of a metal foil (e.g., aluminum) or a metal foil laminate which is glued to the top of the container. Generally, neither the metal foil of the cover nor the glue affixing the cover over the opening of the container is biodegradable, compostable or made from readily renewable resources. As a result, non-biodegradable and non-compostable beverage cartridges typically end up in landfills, thereby at least contributing to environmental concerns associated with disposal of trash. This may be especially problematic due to the fact that traditional means of brewing beverages, e.g., using solely beverage material and filter material, or a filtration device (such as a French press, or a wire mesh filter) may yield a completely compostable waste product (e.g., spent coffee grounds and potentially a used paper filter).

Attempts have been made to recycle plastic beverage pods in some cases. Recycling has many issues which affect the efficacy and practicality of these programs. The first is collection and transportation. Collection largely requires voluntary compliance by consumers. Some deposit programs encourage consumers to return recyclable materials, however this accounts for very few recyclable materials. Collection is further complicated by the need to further transport the materials to a facility which can process them. Many of these facilities are run by municipalities as recycling operations frequently lack economic viability without government subsidies. Recycling of plastics and other materials is further complicated by cross contamination and downcycling. Cross contamination is the presence of foreign materials not desired in the end product and can include materials such as other non-recyclable waste, or other recyclable wastes not compatible with the desired recycled material which can include other plastics. This requires sorting and cleaning of materials. This process can be partially automated; however, it also requires manual sorting and inspection which adds cost, reduces the amount of material that can be processed and inevitably results in a less pure product than when using virgin material. This frequently results in downcycling.

Downcycling is the term used to describe the reduction of quality in recycled materials compared to materials prior to being recycled. Impurities introduced during processing, from non-recyclable waste that could not be removed, or from other plastics and materials can make the resulting material unsuitable for use in their original applications. As such, the applications for recycled materials, especially plastics, are limited, as is the number of times that plastics can be recycled.

Beverage containers, such as instant beverage cups or pods, are particularly difficult to recycle. Not only do they have non-recyclable material contained within them that would first need to be removed, they are frequently comprised of at least two different materials, such as a plastic cup and an aluminum foil lid. When the lid is made of plastic, it is often a different type than the cup, and would require separation prior to processing when being recycled. This increases the complexity of the recycling operation, requiring at least three separate streams for each type of refuse, each requiring their own preparation. Furthermore, the small size of these beverage pods creates a disproportionate amount of effort required to recycle a small amount of material. The separation of materials would ideally be performed by the consumer prior to recycling; however, this inconvenience will inevitably result in consumers recycling the beverage containers without proper preparations, or failing to recycle the container at all, electing to discard the container as trash. One of the major advantages of using beverage pods is consumer convenience, such that a beverage can be prepare by simply inserting a cartridge into a machine that performs all other brewing functions. It is therefore undesirable to instruct consumers to disassemble and sort various materials from beverage pods, and due to the diminutive size of beverage pods, this may not be physically possible for consumers without fine motor skills necessary to disassemble such an item. The result is a required step of preprocessing the containers before they can be recycled to ensure the materials are separated and the recyclable material sufficiently cleaned.

Plastics are traditionally sourced from petroleum. They are processed with chemicals to create polymers which can then be formed into shapes. Such polymers that are heated to be formed and then hold their shape when cooled are called thermoplastics. Many of the chemicals used to produce these polymers are inherently toxic and can leech into the contents. This is why few types of plastics are approved for use with foods. Some materials may be safe storing some types of food products, such as dry goods, however when a solvent is introduced, the chemicals in the plastic can go into solution. In the past, some plastics that were previously approved for use with foods have been found to leech chemicals, such as BPA (Bisphenol A). Depending on the chemical and the manner in which the plastic is being used, it can cause problems including irritation in the eye, vision failure, breathing difficulties, respiratory problems, liver dysfunction, cancers, skin diseases, lung problems, headache, dizziness, birth defects, as well as reproductive, cardiovascular, genotoxic and gastrointestinal issues.

There has been a push from some governments to mandate composting and increase the amount of recycled material to reduce the amount of waste being incinerated or buried in landfills. Some laws such in the European Union, set specific targets, such as 65% of waste recycled by 2035. In the United States, there is no national law, but roughly half of states have some form of recycling law and municipalities may further add to these laws resulting in a varying patchwork of regulations and mandates. Some laws are very limited, requiring that some bottles and cans be recycled. Many of these states also add deposits to bottles, adding monetary value and incentive to returning them for recycling. Others require only specific recyclable materials be recycled, while others may be permitted to be discarded in the trash. Some states go further, mandating that compostable waste be disposed of properly, either in a home composter, or via an industrialized composting operation.

A further complication to composting plastics is that not all plastics break down the same. Some plastics, whether petroleum based, or those which originate from biomass, are biodegradable. Only a small subset of these are also compostable. The distinction lies in how quickly the plastic breaks down, and whether the process of degradation releases harmful chemicals into the environment. Compostable plastics typically degrade within 12 weeks, wherein biodegradable plastics will typically break down within 6 months. Ideally, compostable plastics would break down at the same rate as common food scraps, about 90 days.

Another class of plastics are oxo-degradable plastics. These are different than biodegradable plastics in that they are traditional plastics with additional chemicals which accelerate the oxidation and fragmentation of the materials under UV light and/or heat. This allows the plastics to break down more quickly, however the result is pollution from microplastics, as the plastic molecules themselves do not degrade any faster than their traditional plastic counterparts. There have been efforts in some jurisdictions to ban these plastics.

Polylactic acid (PLA) is typically brittle at room temperature, causing it to crack and fail, under thermal or mechanical stress. Additionally, PLA has a low melting or forming temperature which means that when subjected to high temperatures and pressures, such as in a beverage brewing machine, a beverage pod made of such materials would be prone to failure.

Bioplastics are sustainable materials; however, they may not have the desired physical properties for a given application. As such, methods of processing and reinforcing the material may be required to achieve the necessary properties for applications such as use as a disposable and biodegradable beverage pod. In particular, bioplastics tend to be brittle and are prone to failure at high temperatures and pressures when they are subjected to mechanical stresses.

While composite materials comprising fibers and plastics can mechanically strengthen a formed article, the forming methods can be challenging. Introducing fibers directly into the plastic material prior to forming can cause equipment to clog and the distribution of the fibers may be insufficient to provide the necessary strength to the formed article. Additionally, producing a formed article using layered techniques can create additional problems such as increasing the thickness of the formed article, delamination of the layers, and challenges forming an article comprised of multiple layers in an economical process.

Thermoplastics are typically annealed in a hot air oven in either a batch process or via a continuous conveyor fed oven. This process requires a significant amount of time and energy and the additional equipment required further increases the cost and space needed. Any number of additives may also be added to the PLA to modify mechanical properties, annealing times, etc. Any further reference to PLA should include any variation of PLA such as pure PLA, a blend of PLA and another plastic and/or PLA including one or more additives.

Air is a poor thermal conductor. It neither transfers nor stores heat efficiently. A more efficient thermal conductor is desired for annealing a thermoplastic article which can more efficiently transfer heat to the thermoplastic article and retain more heat which is not transferred to the thermoplastic article so as to be used to anneal another thermoplastic article as opposed to being lost as waste energy.

### BRIEF DESCRIPTIONS OF THE DRAWINGS

FIG. 1 illustrates a beverage pod that may be received by a brewing apparatus.

FIG. 2 illustrates a beverage pod that may include some or all of the features of the beverage pod 100 of FIG. 1.

FIG. 3 illustrates an apparatus that may be used to mold, form, and/or anneal materials when a beverage pod is made.

FIG. 4 illustrates two different views of a cavity side of an annealing mold.

FIG. 5 illustrates several perspective views of a core side of an annealing mold.

FIG. 6 illustrates a series of steps that may be used when an article is formed in mold 300 of FIG. 3.

FIG. 7 illustrates a computing system that may be used to implement an embodiment of the present invention.

### DETAILED DESCRIPTION

A system and method for molding, forming, and annealing an article of manufacture using a series of molds are disclosed. Such systems and methods may melt degradable thermoplastic materials that are then injected into a first mold to form an article of manufacture. This article may then be moved to a second mold where the formed article is annealed. The second mold may be heated based on operation of a heating element that heats the annealing mold reservoirs of fluids that may be used to heat and/or cool articles such as beverage pods during an annealing process. This annealing process may condition materials in the formed article to enhance properties of the article. For example, annealing may improve thermal resistance of the article. Systems of the present disclosure may employ two molds, one mold that forms articles and a second mold that anneals articles to facilitate a continuous production beverage pods using environmentally friendly materials.

In one instance a heating element may control the temperature of a heated fluid provided to the annealing mold. This may include heating a fluid at a fluid reservoir and moving the heated fluid to the annealing mold via one or more valves. The annealing mold may be cooled by a cooled or chilled fluid being provided to the annealing mold after an article contained withing the annealing mold is annealed. While in certain instances the annealing mold may be heated by heated fluids, the annealing mold may be heated without using a heated fluid. Alternative ways that the annealing mold may be heated is by a form of inductive coupling, by heated gasses, or by other forms of radiated heat. In instances when inductive coupling is used, the annealing mold may be made of or include materials that are affected by a magnetic field. For example, the annealing mold may be made of steel, other metal that includes iron, a plastic material impregnated with particles (e.g. steel or iron particles) that are affected by a magnetic field. When inductive coupling is used to heat an annealing mold, a coil of wire within or in proximity to the annealing mold may be energized with an alternating current to create a magnetic field that interacts with magnetic materials in the annealing mold to heat the annealing mold. In certain instances, the annealing mold may be heated using a combination of heating apparatus.

The described method of forming a composite article from plastics and cellulose fibers can improve the thermal and mechanical properties of an article formed by this method compared to one formed only using plastic while reducing production time and costs and improving reliability of the production process. Annealing an article formed via injection molding in a secondary mold increases the speed at which the article may be formed and annealed and reduces the energy required by transferring the heat directly to the formed article without first heating the air around it.

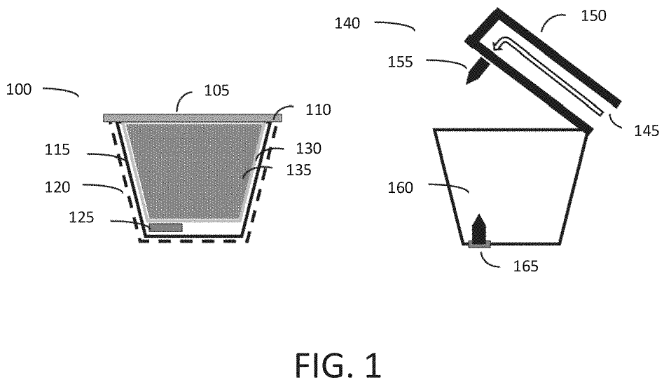

FIG. 1 illustrates a beverage pod that may be received by a brewing apparatus. FIG. 1 includes beverage pod 100 that may be referred to as a beverage cartridge, a beverage container, a pod, or a capsule, etc. that may include a single serve portion of a beverage making material. FIG. 1 includes beverage brewing container 140 of a brewing machine that may receive beverage pod 100 when a beverage such as a coffee a hot chocolate, chai tea is made.

Beverage pod 100 includes beverage making material 135 that may be either a soluble or an insoluble type of material. Beverage pod 100 also includes one or more filters 130 that contain the beverage making material 135, a lid (i.e. pod lid) 105, an outer or exterior wall/surface, an outer coating 120 (or a second outer layer), and filter guard 125. Item 110 of FIG. 1 illustrates an area of beverage pod 100 where lid 105 may be bonded to a portion of beverage pod via bond 110.

Pod lid 105 is a component of a beverage pod 100, that may be made of any suitable material that when bonded to beverage pod 100 seals the beverage making material 135 and filter 130 inside of beverage pod 100. In certain instances pod lid 105 may be comprised of or include a cellulose paper laminated with PLA and/or PBAT (which may contain a proportion of PHA). The pod bond 110 may be formed using any available bonding process, such as adhesive bonding, heat sealing, or, sonic/ultrasonic welding. Bond 110 may bind filter 130 to a portion of an inner surface of beverage pod 100.

An exterior portion of an exterior of a beverage pod is illustrated as item 115. A beverage pod 100 may be made of degradable plastic (e.g. a compostable plastic, such as PLA, PHA, PBAT, or combinations thereof), cellulose, or other type of degradable plastic. Pod exterior 115 may have similar properties to other thermoplastic polymers such as polypropylene (PP), polyethylene (PE), or polystyrene (PS). This allows beverage pods 100 to truly be biodegradable. Degradable beverage pods can also be made from polyhydroxyalkanoates (PHAs), which are a biodegradable polyester produced through bacterial fermentation of sugar or lipids. They can be used as alternatives to other synthetic plastics. The mechanical properties of PHAs can be modified for a given use case by blending it with other biodegradable polymers, such as PLAs. They can also be made from poly(L-lactide) (PLLA), which is a polymer that is also biodegradable and compostable. The material may be used to form various aspects of the beverage pod 100. PLLA is also readily renewable, typically made from fermented plant starch such as from corn, cassava, sugarcane or sugar beet pulp.

Cellulose fibers are fibrous materials made from plant materials such cotton, flax, wood pulp, etc. They provide a biodegradable filter 130 material that could be used in beverage pod 100 filters 130. PLA may have its properties modified by an annealing process. In metallurgy and materials science, annealing is a heat treatment that alters the physical and sometimes chemical properties of a material to increase its ductility and reduce its hardness, making it more workable. PLA may be especially brittle after a manufacturing process (such as injection molding or vacuum thermoforming) and may crack, leak, or other fail to resist the heat and pressure associated with a beverage brewing process. Other materials that are biodegradable plastic alternatives include petroleum-based plastics such as, Polyglycolic acid (PGA), Polybutylene succinate (PBS), Polycaprolactone (PCL), Polyvinyl alcohol (PVOH), Polybutylene adipate terephthalate (PBAT), and ethylene vinyl alcohol (EVOH). Beverage pods 100 can also contain an optional second layer 120 that is separate from a filter 130, in beverages that have an insoluble beverage material 135 such as coffee. The optional second layer 120 can be used for a number of purposes, including, providing material properties such as structural integrity (e.g., provide addition strength to resist the pressure of liquid injection in the process of brewing a beverage, which may crack or otherwise compromise the beverage pod 100), or altering the biodegradability or rate of the beverage pod 100 in some embodiments. A second layer 120 may be added to the pod exterior 115 or may be arranged outside the pod exterior 115. In one instance, the second layer 120 ay be formed of pressed cellulose fibers that are fused to the exterior of a pod exterior 115 made of PLA or a mixture containing PLA. The pod exterior 115 may alternatively be made of any other thermoplastic material.

A brewing machine brewing container 140 is designed to receive brewing pod 100 when a beverage is made by a brewing machine. Brewing container 140 includes a top 150 and a bottom portion 160. Top 150 may be opened before brewing pod 100 is placed in brewing container 140. This top portion 150 includes a fluid source 145 (i.e. a fluid input port) and a brewing pin 155. Bottom portion 160 includes outlet piercing element 165. When a beverage pod 100 is placed in brewing container 140 and lid 150 is closed brewing pin 155 punctures a hole in the top 105 of the beverage pod 100 and piercing element 165 punctures a bottom portion of the beverage pod 100. A brewing fluid (e.g. hot water) may then be applied to fluid source 145 such that the brewing fluid can move into beverage pod 100 through brewing pin 155 such that the fluid can contact brewing material 135 when a beverage is made. The beverage may then exit brewing container 160 via piercing element 165.

Filter guard 125 is a structure that may prevent piercing element 165 from piercing filter 135 when the beverage is made. Filter guard 125, may protect the filter such that undissolved solids contained within the filter will not exit beverage pod 100. Filter guard 125 may also be referred to as a faceplate. Filter guard 125 may be a solid structure integrated into a beverage pod 100. In instances when a beverage pod includes an optional second layer 120, features included in this second layer 120 may act as a filter guard. Filter 130 may be a medium, such as spun bond PLA web, paper (cellulose), cloth or metal, that is used to prevent an insoluble beverage material 135 from leaving the beverage pod 100 and entering the beverage brewing container 140 or the beverage. Filters 130 can be symmetrical (e.g., fluted), or asymmetrical (e.g. pleated). Beverage making material 135 is the material used to produce a brewed beverage. Examples of beverage making materials include coffee grounds, tea leaves, or a beverage mix (such as soluble hot chocolate powder). Beverage material 135 may include any flavorings, nutritional content (e.g., any oils, nutritional supplements, active ingredients such as pharmaceuticals, cannabinoids, etc.), alcohol, coloring, or any other composition which has an effect on the final beverage. Beverage brewing machines for brewing portioned beverages from pre-packed beverage pods 100 exist for a variety of beverages made from a beverage material 135 that is either insoluble, such as coffee, or soluble, such as hot chocolate.

A beverage brewing machine brewing will typically contain many other components besides brewing container 140. For example brewing machines may include a heating element, a liquid reservoir or plumbing component, a liquid pump, an exterior chassis, a controller for the brewing process, a display or indicator lights and sounds, a user interface including buttons or a touchscreen, a tray to catch spillage, etc. For the purposes of description, it is assumed a beverage brewing machine contains all components necessary to accomplish the beverage brewing process, though specific reference to beverage brewing machine components may only be made to those components which come into direct contact with the beverage pod 100, such as the brewing chamber 160, a fluid injecting component, such as a brewing pin 155, and a fluid extracting component such as an outlet 165. A fluid source 145 supplies the liquid, usually water, to the beverage brewing machine 140 for producing the desired beverage.

A brewing chamber lid 150 opens to allow a new beverage pod 100 to be added to the beverage brewing machine container 140, and in many of the most common embodiments of a beverage brewing machine, the chamber lid 150 connects the fluid source 145 to the brewing pin 155, but the fluid source 145 does not have to be in the brewing chamber lid 150. A brewing pin 155, or fluid injecting component, typically has a piercing element to puncture the beverage pod lid 105, that provides a liquid, typically hot water, to mix with the beverage material 135 to create the beverage. A brewing chamber 160 is a receptacle or sieve holder, into which the beverage pod 100 is placed so that a beverage can be brewed. An outlet 128, or fluid extracting component, typically has a piercing element to puncture the bottom of the beverage pod 100 to allow the brewed beverage to leave the brewing chamber 160. Depending upon the embodiment, it may pierce or deform other components of the beverage pod 100.

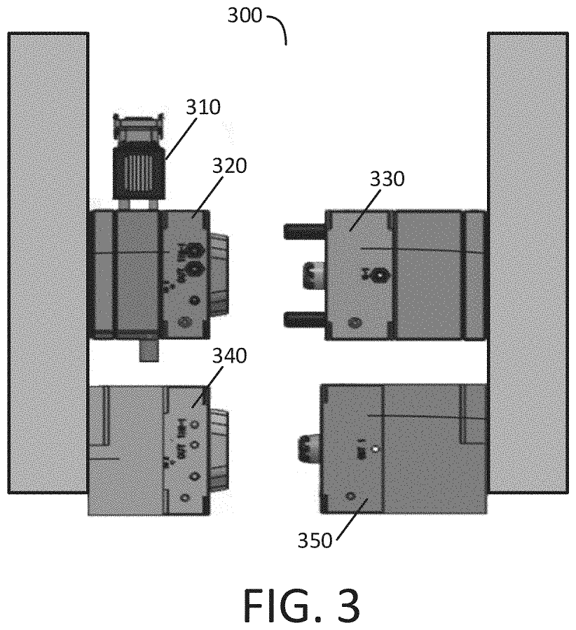

An injection molding machine makes use of a first forming mold, for forming an article from a forming material, and a second annealing mold, for annealing the formed article. Such formation of the article in the first forming mold, requires cooling the article to a temperature such that the article solidifies and does not lose its shape. This low forming temperature may impact the performance of the article and the structure of the articles may be compromised when reheated. Therefore, such articles made up of such forming material may require an annealing process for improving the thermal resistance of the article. Such usage of the second annealing mold for the annealing process, solves the problem of slow production, since using one mold for both forming and annealing requires a significant amount of time and energy as the mold must be reheated after the article has been formed. Certain parts of a forming mold discussed herein are illustrated in FIG. 3.

Further, while using a single mold, another article cannot be formed until that process for a previous article has completed, since the annealing of the article would require the article to stay in the mold in which it was formed. An injection molding machine may have, one or more components such as, but not limited to, a hopper, a melting element, a feeder, an injection nozzle, a forming mold, a transfer actuator, an annealing mold, a fluid reservoir, and a fluid heater. Further, the forming mold and the annealing mold may be adjacent to one another such that the formed article can be removed from the forming mold and moved to the annealing mold for annealing while the next article is formed in the forming mold. This allows a continuous process of forming and annealing. Certain parts of an annealing mold are illustrated in FIGS. 3-5, where FIG. 3 illustrates parts of a forming mold and an annealing mold that may be used to product articles such as beverage pods.

The article may be formed using biodegradable or compostable thermoplastics which are derived from plants such as polylactic acid (PLA). In an embodiment, the article is a beverage pod 100 for use in an apparatus of a beverage brewing machine 140. A hopper may be a storage container for storing one or more forming materials, required for forming the article. In one embodiment, the one or more forming materials may be biodegradable or compostable thermoplastics that are derived from plants, such as a polylactic acid (PLA). The forming material may be chosen based on the required characteristics and intended purpose of the article to be formed.

Further, the hopper may include a hopper feeder to supply the forming materials to the melting element for melting and mixing the forming materials. In one instance, the hopper may have an indicator to represent the capacity of the hopper, the volume of the one or more forming materials in the hopper, pressure, temperature, manufacturer, date of manufacture of the one or more forming material, etc. It can be noted that the indicator may be a digital screen or an analog device. The hopper may be a discharge container that may allow a continuous flow of a forming material at an adequate rate.

The hopper may be a mass flow hopper such as but not limited to, a conical hopper, a wedge plane-flow hopper, a transition hopper, a chisel plane-flow hopper, a pyramid hopper, and a square opening hopper. In certain instances, the hopper may be a core flow hopper such as, but not limited to, a pyramid square opening hopper, a cylindrical flat-bottomed slot opening hopper, a conical hopper, and a cylindrical flat-bottomed circular opening hopper. The hopper may be made of a metal, a hardened plastic, or an alloy. For example, the hopper may store PLA for forming beverage pods 100.

A melting apparatus may then melt and mix the forming material supplied by the hopper. Further, the melting apparatus may include components such as, but not limited to, a heating unit such as a furnace or a heating coil and a storage unit. Further, the melting apparatus may include a thermostat to sense the temperature of the melted forming material and control the heating unit to maintain a melting temperature at a desired set-point. The melting apparatus may include a mixing unit for mixing the melted forming material to increase the uniformity of the melted forming material. In one case, the melting apparatus may receive two or more forming materials and may melt and mix them to create a homogenous and uniform mixture. Further, the melted forming material may be supplied to an injection nozzle and feeding apparatus. For example, the melting apparatus may melt and mix PLA at or above the melting point of PLA (170 degrees Celsius). A feeder coupled to the melting apparatus may feed the melted forming material into a forming mold using an injection nozzle. In one instance, the feeder may be an apron feeder or a rotary table feeder to regulate the discharge from the melting apparatus by passing a continuous flow across the outlet valve of the melting apparatus at a controlled rate.

In another instance, the feeder may be a screw feeder to continuously supply the melted forming material from the outlet valve of the melting apparatus into an injection nozzle. It can be noted that the screw feeder may further enhance the uniformity of the melted forming material. Further, the feeder may hold enough melted forming material required for forming an article. For example, the feeder feeds the melted PLA to the forming mold, via the injection nozzle when a beverage pod is formed. The forming and annealing apparatus 138 may facilitate forming and annealing an article, using the forming material. The forming material may then be transferred from the feeder into the forming mold, via the injection nozzle. The forming mold utilizes a forming mold cavity side and a forming mold core side to form the article. The forming mold cavity side may assist in forming an inside portion of the article and the forming mold core side may assist in forming an outside portion of the article.

Once the article is formed, the formed article may be ejected from the forming mold and transferred to the annealing mold, using a transfer actuator. Such annealing of the formed article may improve the thermal resistance of the thermoplastic of the formed article. The annealing mold may be connected in series with the forming mold. For example, the forming and annealing apparatus facilitates forming and annealing a beverage pod 100 comprised of polylactic acid (PLA). At first, the PLA is transferred from the feeder 136 to the forming mold. Once the beverage pod 100 is formed, the beverage pod 100 is then ejected from the forming mold and moved to the annealing mold, for annealing the beverage pod 100. During the annealing, the beverage pod 100 may first be heated, to a temperature of 90 degrees Celsius and then cooled to a temperature of 2 degrees Celsius using water flowing through the annealing mold. The annealed beverage pod 100 made of the PLA is then ejected from the annealing mold.

An injection nozzle transfers the melted forming material from the feeder to the forming mold. In one embodiment, the injection nozzle may include high-pressure side components such as a high-pressure pump and an accumulator. The injection nozzle may be configured to regulate the amount of forming material, once the accumulator accumulates a required volume of melted forming material for forming one article. For example, the injection nozzle may feed the forming mold with the melted PLA for forming beverage pods 100 like a coffee pod. A forming mold forms the article from the melted forming material injected through the injection nozzle. The forming mold may include two sides, a forming mold cavity side and a forming mold core side. The forming mold cavity side and the forming mold core side may be connected such that, the forming mold cavity side and the forming mold core side may come together to apply high pressure for forming the article from the melted forming material. The forming mold cavity side may assist in forming an inside portion of the article and the forming mold core side may assist in forming an outside portion of the article.

To form the article, the injector nozzle may inject the melted forming material into the forming mold, between the forming mold cavity side and the forming mold core side. The forming mold may facilitate cooling of the thus formed article such that the article does not lose its shape. The forming mold may have an ejection means such as an air outlet on the forming mold cavity side of the forming mold, such that, compressed air may be introduced from the air outlet to loosen the formed article from the forming mold. Additionally, the forming mold core side may have an additional ejection means such as mechanical means like an ejection plate for forcing the article away from the forming mold core side. The additional ejection means may allow the article to be ejected while the bottom of the article is removed. Further, the injection molding machine may include more than one forming mold such as, for making different articles like a beverage pod 100, a disposable plate, bowls, etc. In one embodiment, the forming mold may be made of a metal such as, but not limited to, iron and aluminum. In another embodiment, the forming mold may be made of an alloy such as, but not limited to, steel and stainless steel. In yet another embodiment, the forming mold may be made of non-metals such as graphite capable of withstanding high temperatures. For example, the forming mold forms beverage pods 100 like a coffee pod from the melted PLA.

A transfer actuator may transfer the formed article from the forming mold to the annealing mold. The transfer actuator may utilize vacuum to firmly hold and transfer the formed article from the forming mold to the annealing mold. The transfer actuator may be, but not limited to, a robotic arm, an electric motor, a comb drive, a hydraulic cylinder, or any such mechanism capable of moving in two or three dimensional space, contacting at least one product of an injection mold (such as beverage pods 100) or thermoforming mold, gripping, grasping, suctioning, adhering or otherwise removing the product of forming mold (such as beverage pods 100) from the forming mold and transferring the product of forming mold (such as beverage pods 100) to the annealing mold. For example, the formed article like a coffee pod is transferred to the annealing mold, using a robotic arm. An annealing mold anneals the formed article. The annealing mold may be parallel to the forming mold. The annealing mold may receive the formed article from the forming mold via the transfer actuator. The annealing mold may include two sides, an annealing mold cavity side and an annealing mold core side. The annealing mold cavity side and the annealing mold core side may be connected such that, the annealing mold cavity side and the annealing mold core side may come together to anneal the formed article.

The formed article is received between the annealing mold cavity side and the annealing mold core side. In order to anneal the formed article, the annealing mold may heat the formed article and then cool the received formed article, using a fluid, to improve the thermal resistance of the article. Additionally, the annealing mold may have a fluid inlet and a fluid outlet for allowing a fluid such as oil or water etc. to flow through the annealing mold. In one embodiment, hot fluid may be flowed for heating the annealing mold. In another embodiment, a cold fluid may be flowed for cooling the annealing mold. The temperature of the fluid may be such that the formed article is heated to a specific temperature for a pre-defined duration to achieve desired thermal resistance. The annealing process provides additional resistance to the thermal load of the article. Further, the specific temperature and the pre-defined duration may vary based on the forming material used for forming the article. Further, the annealing mold may also have an air orifice that may be utilized as both an inlet and an outlet. In one embodiment, the air orifice may work as an inlet to create a vacuum to hold the formed article in place. In another embodiment, the air orifice may work as an outlet to introduce compressed air to eject the annealed article from the annealing mold. In another embodiment, the air outlet and the air inlet may be two separate units. Additionally, the annealing mold core side may have an additional ejection means such as mechanical means like an ejection plate for forcing the article away from the annealing mold core side.

In one instance, the annealing mold core side may also have a knife for stamping out the bottom of the article. Therefore, the ejection plate may allow the article to be ejected while the article's bottom is removed. In one embodiment, the annealing mold may be made of metals such as, but not limited to, iron and aluminum. In another embodiment, the annealing mold may be made of an alloy such as, but not limited to, steel and stainless steel. In yet another embodiment, the annealing mold may be made of a non-metal such as graphite capable of withstanding high temperatures. It can be noted that annealing the formed article may increase ductility, improve the thermal resistance, and reduce hardness of the formed article. For example, in the annealing mold, a beverage pod 100 is annealed. The annealing mold cavity side of the forming and annealing apparatus, works in conjunction with the annealing mold core side for annealing the formed article. The formed article is transferred from the forming mold to the annealing mold, via the transfer actuator. The formed article may be kept in place in the annealing mold housing. The annealing mold cavity side may include a fluid inlet and a fluid outlet, that may allow fluid such as oil or water etc. to flow through the annealing mold cavity side 148 for heating and cooling the annealing mold to anneal the formed article.

In one instance, the annealing mold cavity side may be heated by flowing a hot fluid from the fluid inlet, via the annealing mold cavity side, to the fluid outlet. In another embodiment, the annealing mold cavity side may be cooled by flowing a cold fluid from the fluid inlet, via the annealing mold cavity side, to the fluid outlet. In one embodiment, the fluid inlet and the fluid outlet may alternate between the hot fluid and cold fluid. In another embodiment, the annealing mold may have dedicated fluid inlet and the fluid outlet for both hot fluids and cold fluids.

As mentioned above, in one instance a heating element may control the temperature of a heated fluid provided to the annealing mold. This may include heating a fluid at a fluid reservoir and moving the heated fluid to the annealing mold via one or more valves. The annealing mold may be cooled by a cooled or chilled fluid being provided to the annealing mold after an article contained withing the annealing mold is annealed. While in certain instances the annealing mold may be heated by heated fluids, the annealing mold may be heated without using a heated fluid. Alternative ways that the annealing mold may be heated is by a form of inductive coupling, by heated gasses, or by other forms of radiated heat. In instances when inductive coupling is used, the annealing mold may be made of or include materials that are affected by a magnetic field. For example, the annealing mold may be made of steel, other metal that includes iron, a plastic material impregnated with particles (e.g. steel or iron particles) that are affected by a magnetic field.

Additionally, the annealing mold cavity side having an air orifice that may work as an air inlet by pulling the air and creating a vacuum to hold the formed article in the annealing mold, during annealing. Further, the air orifice may work as an outlet to introduce the compressed air to eject the annealed article from the annealing mold. In one embodiment, the air orifice may work both as an inlet and an outlet. For example, the annealing mold cavity side of the annealing mold 146, which works in conjunction with the annealing mold core side to anneal a beverage pod 100 like “Keurig K-Cup®” pods or “Nespresso Capsules” by using hot water at a temperature of 90 degrees Celsius and then using cold water at a temperature of 2 degrees Celsius flowing through the annealing mold cavity side 148. The annealing mold core side of the forming and annealing apparatus, works in conjunction with the annealing mold cavity side, for annealing the formed article.

The formed article may be transferred from the forming mold to the annealing mold, via the transfer actuator. The annealing mold core side may include a core mold, a bottom punch, an air orifice, an ejection plate, a fluid inlet, and a fluid outlet. The core mold may be configured to be placed in the annealing mold core side such that, the formed article may be kept between the annealing mold cavity side and the annealing mold core side. Additionally, the air orifice may work as an air inlet by pulling the air and creating a vacuum to hold the formed article in place during annealing. Further, the fluid inlet and the fluid outlet may allow fluid such as oil or water, etc. to flow through the annealing mold core side for heating and cooling the annealing mold to anneal the formed article. In one embodiment, the annealing mold core side may be heated by flowing a hot fluid from the fluid inlet, via the annealing mold core side, to the fluid outlet. In another embodiment, the annealing mold core side may be cooled by flowing a cold fluid from the fluid inlet, via the annealing mold core side, to the fluid outlet. Further, the air orifice may work as an outlet to introduce compressed air to eject the annealed article from the annealing mold. In one embodiment, when the bottom of the formed article must be removed, the bottom punch of the core mold may be configured to cut out the bottom of the formed article to create a hollow cylinder with no top or bottom and the ejection plate may be configured to eject the formed article mechanically since the ejection by the air orifice may be ineffective in such cases. For example, the annealing mold core side of the annealing mold, which works in conjunction with the annealing mold cavity side to anneal a beverage pod 100, like “Keurig K-Cup®” pods or “Nespresso Capsules” by using hot water at temperature of 90 degrees Celsius and then using cold water at a temperature of 2 degrees Celsius flowing through the annealing mold core side.

A fluid reservoir stores one or more fluids that may flow through the annealing mold to anneal the formed article in the annealing mold. Further, the fluid may be water, oil or any other fluid with desired thermal and flow characteristics. In one embodiment, the fluid reservoir may be coupled to an additional reservoir for cooling the liquid. In another embodiment, the fluid reservoir may have two or more compartments to store hot and cool fluids separately, such as the fluid reservoir 152 may store a hot fluid for heating the annealing mold and/or the fluid reservoir may store a cold fluid for cooling the annealing mold. Further, the fluid reservoir may include a fluid heater for heating the fluid and/or a chiller to cool the fluid. For example, the fluid reservoir stores water used for annealing the formed article, for example, a beverage pod 100. A fluid heater heats the fluid stored in the fluid reservoir, to be fed into the annealing mold. The fluid heater may include a heating unit such as a furnace or a heating coil for heating the fluid. The fluid heater may also be coupled to a thermostat to sense the temperature of the fluid and control the heating unit to maintain the temperature of the fluid at the desired set-point. The temperature of the fluid may be such that the formed article is heated to a specific temperature for a pre-defined duration to achieve desired thermal resistance and the temperature and the pre-defined duration may vary based on the forming material used for forming the article. In some instances, the fluid heater may also include a chiller for cooling the fluid. Further, the fluid heater may also include a heat exchanger for recovering heat from warmed cooling liquid. For example, the fluid heater heats the water to a temperature of 90 degrees Celsius. A forming and annealing module is the process of forming and annealing an article of manufacture. The forming and annealing module may utilize a series of molds, a forming mold for forming the article and an annealing mold for annealing the formed article. The article is formed using a forming material which is melted and transferred, from the feeder via the injection nozzle, to the forming mold. Thereafter, the forming mold utilizes the forming mold cavity side and the forming mold core side to together facilitate forming of the article.

The formed article may then transferred to the annealing mold, using a transfer actuator, for annealing. Such annealing process may be used to increase ductility and thermal resistance and reduce the hardness of the formed article, by first heating the formed article in the annealing mold and then cooling the formed article in the annealing mold. Such heating and cooling of the article in the annealing mold is performed using a fluid flowing around the annealing mold. The temperature of the fluid is such that the formed article is heated to a specific temperature for a pre-defined duration to achieve the desired thermal resistance. For example, for manufacturing a beverage pod 100 made of the forming material polylactic acid (PLA), PLA is stored in the hopper 132. Examples of a beverage pod 100 include “Keurig K-Cup®” pods, “Nespresso Capsules”, etc. The PLA is then transferred from the hopper to the melting element for melting and mixing of the PLA. The melting apparatus then melts the PLA at least at a temperature of 170 degrees Celsius and transfers the melted PLA to the feeder. Further, the feeder injects the melted PLA into the forming mold, using the injection nozzle. The forming mold then forms a beverage pod 100 such as a coffee pod made of PLA, using a forming mold cavity side and the forming mold core side. The beverage pod thus formed, is then transferred to the annealing mold using the transfer actuator, for annealing the beverage pod 100. The beverage pod 100 is first heated using water, at a temperature of 90 degrees Celsius and then cooled at 2 degrees Celsius to improve the thermal resistance of the beverage pod 100. The annealed beverage pod 100, such as a coffee pod made of PLA, is then ejected from the annealing mold. The annealing process provides additional thermal resistance to the beverage pod 100.

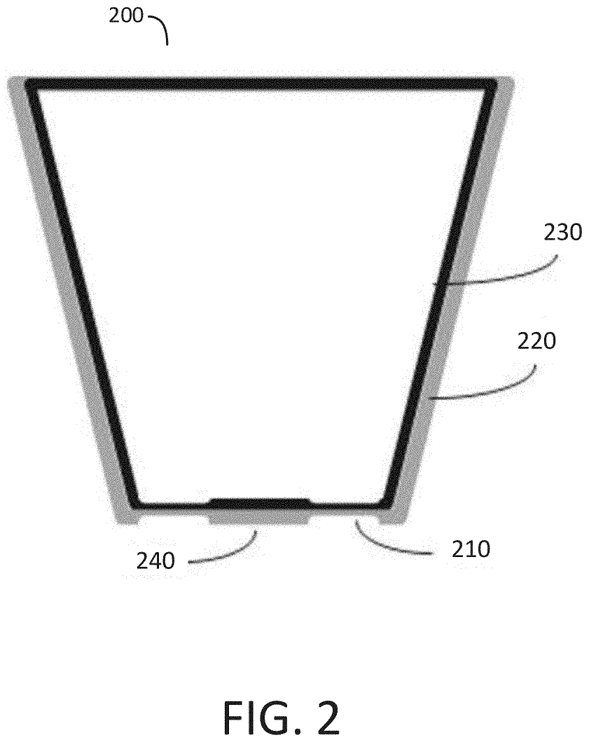

FIG. 2 illustrates a beverage pod that may include some or all of the features of the beverage pod 100 of FIG. 1. FIG. 2 may include two layers of material which are heated and compressed such that they become fused or bonded into a single structure 210 in a manner that makes these layers not easily separated. The compression additionally cause the fused layers to decrease in thickness. In an embodiment, a first layer 230 is a thermoplastic material such as PLA, or a mixture of PLA and another thermoplastic material and a second layer 220 is comprised of pressed cellulose fibers. The first layer 230 and second layer 220 may be heated and compressed such that the first layer 230 comprised of thermoplastic material is softened to penetrate the outermost surface of the second layer 220 comprised of pressed cellulose fibers. The penetration of the thermoplastic material into the cellulose material may be complete, saturating the cellulose material such that the thermoplastic emerges on the opposite side of the cellulose material.

Alternatively, the thermoplastic may be pressed into, but not penetrate the cellulose material such that the resulting fused layer structure 210 includes a friction bond. In certain instances, the first layer 230 and second layer 220 may each have a thickness of 1 mm and the resulting fused layer structure 210 may be compressed to less than 0.75 mm thickness. The first layer 230 and the second layer 220 may be interchangeable such that one may be on the interior of the formed article while the other is on the outside or vice versa. Similarly, if more than two layers comprise the fused layers 210, the order of each layer may similarly be interchanged or alternated.

The fused layers 210 comprise a mixture of thermoplastic and cellulose material combined before, during or after being formed into a formed article. The second layer 220 may be comprised of a cellulose material. The cellulose material may be pressed into the shape of a formed article to which it is to be mated Such a pressed shape may be slightly larger or smaller than the formed article to which it is to be mated so as to fit within or outside of the formed article.

Alternatively or additionally, the second layer 220 may be initially comprised of a sheet of pressed cellulose fibers to be formed before or during the forming of a thermoplastic article to be formed by the first layer 230 of material. A second layer 220 may be formed on the exterior of a beverage pod before or during the forming of the first layer 230. This may include introducing the thermoplastic material comprising the first layer 230 prior to a pod being formed. Alternatively, or additionally a cellulose material be applied to an electrostatically charged forming mold prior to the introduction of the thermoplastic material to form the first layer 230 around the second layer 220.

The first layer 230 may be comprised of a thermoplastic material or a mixture of multiple thermoplastic materials. The first layer 230 may additionally be comprised of one or more additives intended to improve one or more properties of the thermoplastic material. In one instance, the thermoplastic material is PLA. In other instances, the thermoplastic material may comprise a mixture of thermoplastics that include PLA. The first layer 230 may further form an exterior portion of beverage pod 200. The first layer 230 may further be comprised of any material which may be used in a beverage pod 200 including those which may be used to form the exterior of beverage pod 200.

The first layer 230 may be formed independent of the second layer 220 and later the two layers may be fused together. Alternatively, the first layer 230 and the second layer 220 may be formed into an article simultaneously. The pod bottom 240 is the lowermost surface of beverage pod 200 which may be inserted first into a brewing chamber of a beverage brewing machine when a beverage is made. At this time pod bottom 240 is pierced by an outlet pin like pin 165 of FIG. 1. A region of fused structure 210 located on the pod bottom 240 may be thinner that other parts of the fused structure 210 such that an outlet pin of a beverage brewing machine can puncture the brewing pod more easily. In such embodiments.

FIG. 3 illustrates an apparatus that may be used to mold, form, and/or anneal materials when a beverage pod is made. Mold 300 includes forming parts 320 & 330 and annealing parts 350 & 350. Item 310 of FIG. 3 is an injection nozzle that may transfer a melted forming material received from a feeding device when a beverage pod is molded from melted materials or when a beverage pod is formed from a material. Injection nozzle 310 may be configured to regulate a required volume of a melted forming material is used to make an article. This may include controlling the flow of melted thermoplastic material into a forming mold portion 320. The injection nozzle may additionally include sensors including temperature and pressure sensors and a heating element to ensure the thermoplastic remains at the desired temperature and to prevent clogging. The injection nozzle 310 may include or be coupled to high-pressure side components such as a high-pressure pump, for improving the injection of materials. For example, the injection nozzle 310 may transfer melted PLA from a feeder (not illustrated) into a cavity section 320 of mold 300.

Injection nozzle 310 may include or be coupled to a gate that controls the flow of melted thermoplastic material into a forming core side 320 of mold 300. Injection nozzle may be used to control any of a pressure, a flow rate, or an amount of melted thermoplastic material which is forced into the core side 320 of mold 300. The injection nozzle 310 may additionally include sensors (e.g. temperature and/or pressure sensors) and a heating element to ensure the thermoplastic remains at the desired temperature. This may also help prevent clogging of materials. Injection nozzle 310 may be made of one of more of metal, metal alloys, or any heat resistant material including ceramics and heat resistant plastics.

The forming mold cavity side 320 works in conjunction with the forming mold core side 330 to form the article. This may be based on the forming material received from nozzle 310. The forming mold cavity side 320 may assist in forming an inside portion of the article. In certain instances, the forming mold cavity side 320 may include means for ejecting formed parts. For example, an air inlet may provide air may to the cavity side 320 of mold 300 to loosen the formed article. The forming mold cavity side 320 may work in conjunction with the forming mold core side 330 to form forms beverage pod 100 of FIG. 1 using a material such as PLA. Examples of a beverage pod 100 include “Keurig K-Cup®” pods, “Nespresso Capsules”, etc. The forming mold core side 330 may work in conjunction with the forming mold cavity side 330 to form the article based on the forming material received via the aforementioned feeder and/or injection nozzle. The forming mold core side 320 may assist in forming an outside portion of the article. The forming material may be received from the feeder via injection nozzle 310.

The cavity forming mold 320 may be used with a core forming mold 330 in an injection molding process or may be used independently in a blow molding or thermoforming process. The core forming mold portions 320 & 330 may be used in an injection molding process or may be used independently as a buck in a thermoforming process. In some embodiments, the cavity forming mold 320 may receive cellulose fibers into which thermoplastic material is formed. In such processes, the thermoplastic may bond with the cellulose fibers to create a bond between the exterior of a beverage pod formed by the thermoplastic. This process may include forming different layers of materials. A first layer of thermoplastic and a second layer of cellulose fibers, for example. This may result in an interior of a beverage pod being made of thermoplastic and an exterior of the beverage pod being made of cellulose fiber.

In some instances, the core forming mold 330 may be used to form a second layer of materials. Here again this second layer may be comprised of cellulose fibers onto which thermoplastic material is formed. In such a processes, a thermoplastic may be bonded with the cellulose fibers to create a bond between the thermoplastic and the cellulose fibers resulting in an interior of cellulose fiber and an exterior of thermoplastic.

The forming mold core side 330 may include one or more ejection means, for example an ejection plate for forcing the formed article away from the forming mold core side 330. This ejection means may allow the formed article to be ejected while the bottom of the article is removed. For example, the forming mold core side 330 working in conjunction with the forming mold cavity side 320 may be used to form, forms a beverage pod 100 using the PLA. The annealing mold cavity side 340 works in conjunction with the annealing mold core side 210, when the formed article is annealed. This may include slowly cooling or heating and then slowly cooling the formed article.

Once the article is formed, it may be transferred from a forming mold to an annealing mold. This may include the use of a transfer actuator that transfers a formed article from the forming parts of mold 300 (i.e. items 320 & 330) to the annealing portion of mold 300 (i.e. items 340 & 350). This transfer actuator may use a vacuum to firmly hold and transfer the formed article from the forming part of mold 300 to the annealing part of mold 300. A transfer actuator may include a robotic arm, an electric motor, a comb drive, a hydraulic cylinder, or any such mechanism capable of moving in items in two or three dimensional space. This transfer may include gripping, grasping, suctioning, adhering or otherwise removing the product of forming part of mold 300. For example, the formed article may be a coffee pod that is transferred to the annealing portion mold 300, using a robotic arm. After the pod is moved it may be annealed. The annealing mold portions 340 & 350 of FIG. 3 may be parallel to the forming mold portions 320 & 330. Annealing mold portion 340 may be referred to as an annealing mold cavity side and annealing mold portion 350 may be referred to as an annealing mold core side. The annealing mold cavity side 340 and the annealing mold core side 350 may be connected such that, the annealing mold cavity side 340 and the annealing mold core side 350 may come together to anneal the formed article.

The formed article may be placed between the annealing mold cavity side 340 and the annealing mold core side 350. The annealing mold cavity side 340 include a fluid inlet and a fluid outlet that allows fluids such as oil or water flow through a portion of the annealing mold cavity side 340. These fluids may be used to heat an article, using a hot fluid and then cool the article, using a cold fluid when the article is annealed via a process that controls heating and cooling. In one embodiment, the annealing mold cavity side 340 may comprise a holding means such as an air inlet in the annealing mold cavity side 340 for holding the article in place in the annealing mold. The annealing mold cavity side 340 may comprise an air orifice which may be used as an inlet to hold the article in the annealing mold using a vacuum. This air orifice may also output gas (e.g. pressurized air) to eject the article.

The annealing mold cavity side 340 may include one or more ejection means such as an air outlet through which compressed air may be introduced in the annealing mold to loosen the annealed article from the annealing mold. For example, the annealing mold cavity side 340 which works in conjunction with the annealing mold core side 350, may anneal a beverage pod 100, by using hot water at a temperature of 90 degrees Celsius and then cold water at a temperature of 2 degrees Celsius. The annealing mold core side 350 may work in conjunction with the annealing mold cavity side 340 to anneal a formed article. The annealing mold core side 350 may also include a knife for stamping out the bottom of the article. An ejection plate may allow the annealed article to be ejected while the article's bottom is removed, by the air outlet from a mold.

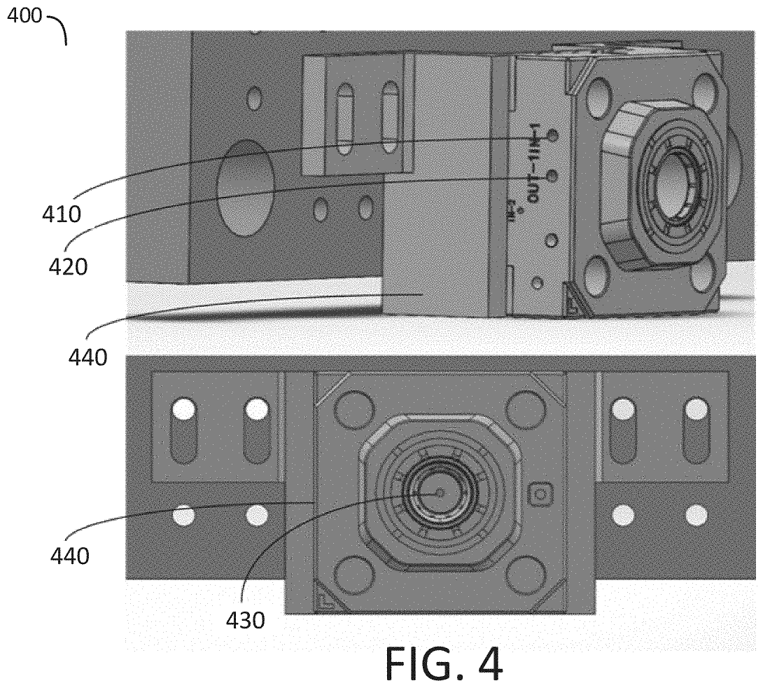

FIG. 4 illustrates two different views of a cavity side of an annealing mold. FIG. 4 illustrates fluid inlet 410 where a fluid flow may be provided to the annealing module cavity side. This fluid may be used for heating or cooling an annealing mold 400. The annealing module cavity side may have one or more fluid inlets 410. Temperature of the fluid provided via the fluid inlet 410 may be such that the formed article is heated to a specific temperature for a pre-defined duration of time to achieve desired thermal resistance. This temperature and the pre-defined duration may vary based on a type or an amount of material used to form an article. The fluid inlet 410 may be connected to a fluid reservoir (not illustrated). Here again the fluid may include yet is not limited to oil or water. Fluid inlet 410 may provide water at a temperature of 90 degrees Celsius to a cavity side of an annealing mold.

FIG. 4 also includes fluid outlet 420 which allows the fluid to flow out of the cavity side of the annealing mold. Here again by moving heated or cooled fluids through the annealing mold, a formed article may be controllably annealed. Such an annealing module cavity side may include one or more fluid outlets 420. Fluid outlet 420 may be connected to the fluid reservoir for receiving the fluid from the annealing module cavity side of the annealing mold.

Air orifice 430 may be used as a port to create a vacuum for securing the formed article in the annealing mold. Alternatively, or additionally the air orifice 430 may be used as an outlet to introduce compressed air for ejecting an annealed formed article, from the cavity side of the annealing mold. An annealing mold housing 440 encloses half of the annealing mold and may include at least one fluid inlet 412 and at least one fluid outlet 420. The annealing mold housing 440 may be comprised of the same material as the forming surfaces of the annealing mold or may be comprised of one or more materials which may be different than the forming surfaces of the annealing mold. The annealing mold housing 440 may be comprised any of a metal, metal alloy, thermoplastics, or ceramics and may additionally include insulative materials such as fiberglass.

A cavity annealing mold 400 may be part of an annealing portion of mold 300 of FIG. 3 that contacts an exterior of a formed article. In some instances, such a cavity annealing mold may instead contact the exterior of a second layer of material that will be fused to the exterior of the formed article. The cavity annealing mold may additionally include one or more fusing elements for fusing a first layer and a second layer together using heat and/or pressure. Fusing elements of the cavity annealing mold portion 340 of FIG. 3 may align with corresponding fusing elements of the core annealing mold portion 350 of FIG. 3.

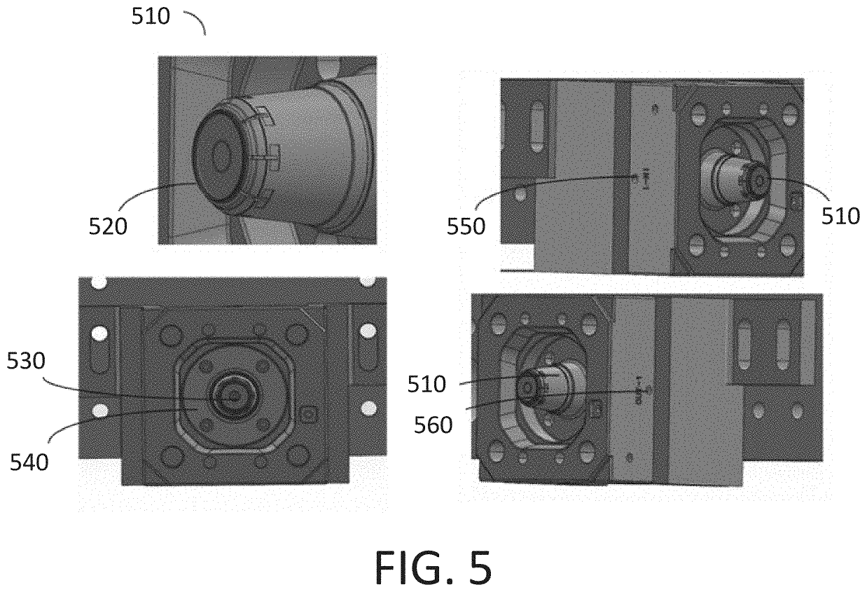

A cavity annealing mold may include a heating element, which conducts heat to the cavity annealing portion of the annealing mold. This heating element may be electric or may utilize thermally conductive materials to transfer heat to the cavity portion of the annealing mold. The cavity annealing mold 400 of FIG. 4 may be used in tandem with a core annealing mold 500 of FIG. 5 to fuse together an exterior portion 220 of beverage pod 200 of FIG. 2 with a second layer 230 of beverage pod 200. Here the second layer may be comprised of cellulose fibers. After the beverage pod is formed it may be placed into the cavity portion of an annealing mold using a transfer actuator where a second layer may be applied before the different a cavity portion and a core portion of an aneling mold are coupled together. A pod exterior portion and the second layer may then be fused together at an appropriate pressure and or temperature. The order in which a pod exterior portion and the second layer are stacked may be changed. Similarly, additional layers may be introduced in any number of arrangements.

FIG. 5 illustrates several perspective views of a core side of an annealing mold. FIG. 5 includes core mold portion 510 that may apply heat to an inside part of the formed article during the annealing process. For example, the core mold 510 contacts the interior surfaces of a beverage pod 100, to transfer heat to the inside of the beverage pod 100. A heated fluid provided to inlet 550 may heat the inside part of the formed article. Item 520 of FIG. 5 may be a bottom punch that is affixed to the core mold 510, this punch 520 may be used to cut out the bottom of the formed article to create a hollow cylinder with no top or bottom. Such a bottom punch 520 may be a part of core mold 510. Further, bottom punch 520 may be made of materials that include yet are not limited to steel, aluminum, ceramic, or the same material that of the annealing mold is made of. Bottom punch 520 may cut a part of a beverage pod 100 to create a hollow cylinder, either by using pressure to sheer off a portion of the bottom of the article, by using a sharp blade, or by using heat to melt the portion of the bottom of a beverage pod. Note that when an article is formed, the annealing cavity portion 400 of FIG. 4 and the annealing core portion 500 of FIG. 5 may be attached to each other after a formed beverage pod is moved from a beverage pod forming mold to the beverage pod annealing mold. Compressive forces and temperatures may be varied to anneal and possibly fuse materials of a beverage pod.

Air orifice 530 may be used both as an inlet and an outlet for moving air into and out of the core side 510 of the annealing mold. The air orifice 530 may be used as an inlet to create a vacuum for securing a formed article in the annealing mold. Alternatively, or additionally, the air orifice 530 may be used as an outlet for ejecting the annealed formed article using pressurized air. In certain instances, an ejection plate 540 may be used to mechanically eject the formed article from the annealing mold core side. The ejection plate 540 of the annealing mold core side may eject a beverage pod from the annealing mold after an annealing process is complete. Fluid inlet 550 may allow a fluid to flow into the core side of the annealing module to heat or cool the annealing mold and a contained formed article. The annealing module core side may have one or more fluid inlets 550. Temperature of the fluid via the fluid inlet 550 may be controlled such that the formed article is heated to a specific temperature for a pre-defined duration to achieve desired thermal resistance. This temperature pre-defined duration may vary based on the forming material used for making the article.

Fluid inlet 550 may be connected to a fluid reservoir such that the fluid may be provided to inlet 550 after it has been heated or cooled. Here again the fluid may be oil, water, or some other fluid. Fluid inlet 550 may provide water at a temperature of 90 degrees Celsius to flow into the core side of the annealing mold. Alternatively. or additionally a flow of cold water at a temperature of 2 degrees Celsius may be provided to inlet 550 during an annealing process.

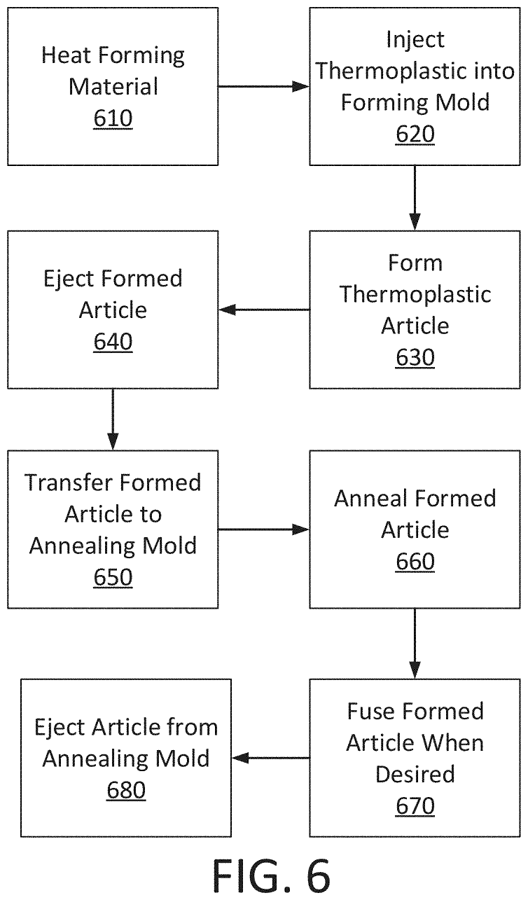

FIG. 6 illustrates a series of steps that may be used when an article is formed in mold 300 of FIG. 3. The process begins with step 610 where a material used to form an article such as a beverage pod is heated. This may include melting a thermoplastic material such as polylactic acid (PLA) or other materials discussed above in a melting apparatus that may include a hopper. The forming material may be stored in this hopper. An apparatus may be used to move the forming material to the melting apparatus. An example of a moving apparatus is a belt feeder. The forming material may be a biodegradable or compostable thermoplastic. The melting apparatus may heat the forming material to a temperature where the material melts. This may include use of a heating unit such as a furnace or a heating coil. For example, the apparatus may heat the PLA to a temperature of 170 degrees Celsius to melt the forming.

After the forming material is melted, it may be injected into a forming mold in step 620 of FIG. 6 via nozzle 310 of FIG. 3. An apparatus that feeds melted material to an injection nozzle may be a screw feeder that mixes the melted forming material in a manner that maintains a uniformity of the melted forming material. This injection process may use high-pressure components to inject the melted forming material into the forming mold. This may include injecting the melted material into the cavity side 320 and the core side 330 of mold 300. This may facilitate the forming the melted material into a shape of an article in step 630.

After an article is formed, the article may be ejected from a forming mold cavity side in step 640 of FIG. 6. This may include separating from a core side from a cavity side of an forming mold. As mentioned above, such an ejection process may be facilitated using a pressurized gas (such as air). By introducing compressed air into the cavity side of the injection mold, the formed article may be freed from the forming mold. In instances, the article may be ejected from the forming mold core side after separating from the forming mold cavity side using an ejection plate that forces the article away from the core side of the forming mold. Once the formed article is ejected from the forming mold, it may be transferred to an annealing mold in step 650. As mentioned above, a transfer actuator may use a vacuum force to firmly hold the article after it has been ejected when the article is being moved to the annealing mold. In certain instances, a vacuum may also be used to remove the formed article from the forming mold.

The formed article may be placed between the annealing mold cavity side and a core side of an annealing mold. Here, the transfer actuator may transfer a formed beverage pod to the annealing mold using an electric motor, robotic arm, or other apparatus. The formed beverage pod may be placed directly into the cavity side of the annealing mold and the mold may be closed by connecting the cavity side of the annealing mold to the core side of the annealing mold. In step 660 of FIG. 6, the article may be formed by a process that first controllably heats and then cools the article. This annealing step may improve the thermal resistance of the formed article. It can be noted that to heat and cool the article in the annealing mold, the annealing mold may have a fluid inlet and a fluid outlet for allowing a fluid such as oil or water to flow through the annealing mold. The fluid inlet may be configured to flow a hot fluid for heating the article in the annealing mold. Additionally, or alternatively the fluid inlet may be configured to flow a cold fluid for cooling the article in the annealing mold. The temperature of the fluid may be such that the formed article is heated to a specific temperature for a pre-defined duration to achieve the desired thermal resistance. Further, the specific temperature and the pre-defined duration for annealing the article may vary based on the forming material. For example, the formed beverage pod 100 of FIG. 1 may be heated by flowing hot water with temperature 90 degrees Celsius and thereafter, the beverage pod may be cooled by flowing cold water with temperature 2 degrees Celsius, through the annealing mold.

Next in step 670 of FIG. 6 the formed article may be fused with additional materials that may be of a same type of material or a different type of material injected into the forming mold in step 620. This fusing step may include applying heat and/or pressure from one or both sides of the formed article forcing the thermoplastic material into the cellulose fibers when a second layer is added to the formed article. In one instance, the article formed in step 630 may include or be comprised of PLA and the second layer may include or be comprised of cellulose fibers. This may include a first fusing element and a second fusing element that mate together as the materials are heated. This fusing process may include controlling a heat and a pressure applied to an exterior surface of a beverage pod. These two fusing elements may be the cavity side and the core side of the annealing mold discussed above. These fusing elements may be heated to a temperature of 170° C. for a time of 2 seconds. This may allow the PLA material to melt where it is in contact with the fusing elements such that the PLA infuses into the cellulose fibers of the second layer. Because of this a transition area between PLA and cellulose may include both PLA and cellulose.

The heat and pressure discussed above may cause the exterior surface of a beverage pod and second layer to compress when fusing together and form a structure that is relatively thinner than a stack up of the original cellulose and PLA materials.

In certain instances, a bottom portion of a beverage pod and second layer are fused together at a location where an outlet piercing element (e.g. element 165 of FIG. 1) of a beverage machine is intended to contact the bottom of the beverage pod. This fusing action may account for the reduced wall thickness of the bottom of beverage pod 200 of FIG. 2. Materials may also be fused at a top rim of the beverage pod. This may help prepare this top surface to receive a pod lid after the beverage pod has been filled with a beverage material, such as coffee, tea, or chocolate. Here again, this top portion of the beverage pod may be thinner than other parts of the beverage pod because of the compression of the fusing process. As mentioned above an annealing mold may function as a fusing element causing the entirety of the pod exterior 108 and the second layer 110 to be fused together. Alternatively, the pod exterior and a second or subsequent layer may be formed, annealed, and fused in the forming mold before an annealing process. This means that step 670 may be performed with or after step 630. In certain instances, the forming and annealing processes may be performed without a fusing step.

Processes other than injection molding that may be used to form an article may include, by layering and thermoforming the materials together, forming and fusing different layers together in a single action. The same process may be utilized for blow molding. Alternatively, cellulose fibers may be introduced into thermoplastic material before or during the forming process.

Next, in step 680 of FIG. 6, the article may be ejected from the annealing mold. In certain instances, the article may be removed with or without a transfer actuator. When a transfer actuator is used, it may physically manipulate the article. The fused article may be loosened from the annealing mold using pressurized air, mechanical ejection mechanism (e.g. an ejection plate), gravity, and/or vacuum to eject the article.

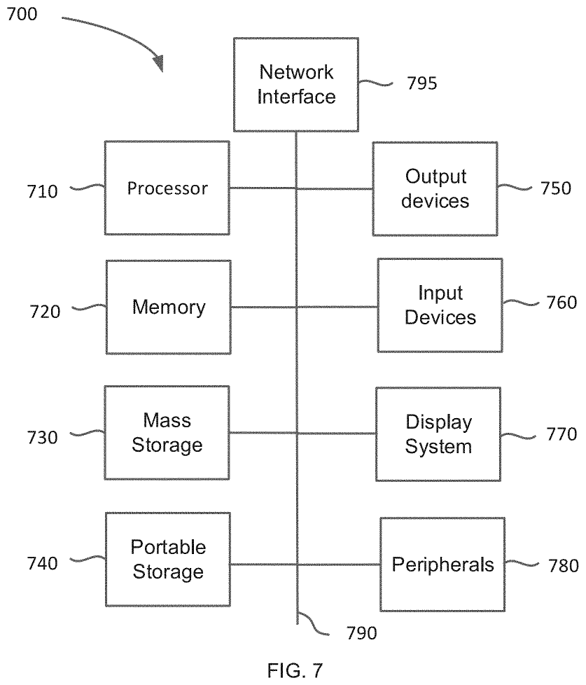

FIG. 7 illustrates a computing system that may be used to implement an embodiment of the present invention. The computing system 700 of FIG. 7 includes one or more processors 710 and main memory 720. Main memory 720 stores, in part, instructions and data for execution by processor 710. Main memory 720 can store the executable code when in operation. The system 700 of FIG. 7 further includes a mass storage device 730, portable storage medium drive(s) 740, output devices 750, user input devices 760, a graphics display 770, peripheral devices 780, and network interface 795.

The components shown in FIG. 7 are depicted as being connected via a single bus 790. However, the components may be connected through one or more data transport means. For example, processor unit 710 and main memory 720 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present invention for purposes of loading that software into main memory 720.

Portable storage device 740 operates in conjunction with a portable non-volatile storage medium, such as a FLASH memory, compact disk or Digital video disc, to input and output data and code to and from the computer system 700 of FIG. 7. The system software for implementing embodiments of the present invention may be stored on such a portable medium and input to the computer system 700 via the portable storage device 740.

Input devices 760 provide a portion of a user interface. Input devices 760 may include an alpha-numeric keypad, such as a keyboard, for inputting alpha-numeric and other information, or a pointing device, such as a mouse, a trackball, stylus, or cursor direction keys. Additionally, the system 700 as shown in FIG. 7 includes output devices 750. Examples of suitable output devices include speakers, printers, network interfaces, and monitors.

Display system 770 may include a liquid crystal display (LCD), a plasma display, an organic light-emitting diode (OLED) display, an electronic ink display, a projector-based display, a holographic display, or another suitable display device. Display system 770 receives textual and graphical information, and processes the information for output to the display device. The display system 770 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 780 may include any type of computer support device to add additional functionality to the computer system. For example, peripheral device(s) 780 may include a modem or a router.

Network interface 795 may include any form of computer interface of a computer, whether that be a wired network or a wireless interface. As such, network interface 795 may be an Ethernet network interface, a BlueTooth™ wireless interface, an 802.11 interface, or a cellular phone interface.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer can also include different bus configurations, networked platforms, multi-processor platforms, etc. The computer system 700 may in some cases be a virtual computer system executed by another computer system. Various operating systems can be used including Unix, Linux, Windows, Macintosh OS, Palm OS, Android, iOS, and other suitable operating systems.

The present invention may be implemented in an application that may be operable using a variety of devices. Non-transitory computer-readable storage media refers to any medium or media that participate in storing and providing instructions to a central processing unit (CPU) for execution. Such media can take many forms, including, but not limited to, non-volatile and volatile media such as optical or magnetic disks and dynamic memory, respectively. The term non-transitory computer-readable storage media does not refer to transitory signals. Common forms of non-transitory computer-readable media include, for example, a FLASH memory/disk, a hard disk, magnetic tape, any other magnetic medium, a CD-ROM disk, digital video disk (DVD), any other optical medium, RAM, PROM, EPROM, a FLASH EPROM, and any other memory chip or cartridge.

The steps of FIG. 6 may be controlled by a computing device that adjusts temperatures of certain parts of machines used to fabricate articles. Here a processor that executes instructions out of a memory may set heating or cooling temperatures, adjust flow rates of particular materials (e.g. melted thermoplastic, heated fluids, chilled fluids, or cellulose). The processor may receive data from sensors or may set an operating temperature that is controlled by another device.

FIG. 7 illustrates a computing system that may be used to implement an embodiment of the present invention. The computing system 700 of FIG. 7 includes one or more processors 710 and main memory 720. Main memory 720 stores, in part, instructions and data for execution by processor 710. Main memory 720 can store the executable code when in operation. The system 700 of FIG. 7 further includes a mass storage device 730, portable storage medium drive(s) 740, output devices 750, user input devices 760, a graphics display 770, peripheral devices 780, and network interface 795.

The components shown in FIG. 7 are depicted as being connected via a single bus 790. However, the components may be connected through one or more data transport means. For example, processor unit 710 and main memory 720 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present invention for purposes of loading that software into main memory 720.

Portable storage device 740 operates in conjunction with a portable non-volatile storage medium, such as a FLASH memory, compact disk or Digital video disc, to input and output data and code to and from the computer system 700 of FIG. 7. The system software for implementing embodiments of the present invention may be stored on such a portable medium and input to the computer system 700 via the portable storage device 740.

Input devices 760 provide a portion of a user interface. Input devices 760 may include an alpha-numeric keypad, such as a keyboard, for inputting alpha-numeric and other information, or a pointing device, such as a mouse, a trackball, stylus, or cursor direction keys. Additionally, the system 700 as shown in FIG. 7 includes output devices 750. Examples of suitable output devices include speakers, printers, network interfaces, and monitors.

Display system 770 may include a liquid crystal display (LCD), a plasma display, an organic light-emitting diode (OLED) display, an electronic ink display, a projector-based display, a holographic display, or another suitable display device. Display system 770 receives textual and graphical information, and processes the information for output to the display device. The display system 770 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 780 may include any type of computer support device to add additional functionality to the computer system. For example, peripheral device(s) 780 may include a modem or a router.

Network interface 795 may include any form of computer interface of a computer, whether that be a wired network or a wireless interface. As such, network interface 795 may be an Ethernet network interface, a BlueTooth™ wireless interface, an 802.11 interface, or a cellular phone interface.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer can also include different bus configurations, networked platforms, multi-processor platforms, etc. The computer system 700 may in some cases be a virtual computer system executed by another computer system. Various operating systems can be used including Unix, Linux, Windows, Macintosh OS, Palm OS, Android, iOS, and other suitable operating systems.

The present invention may be implemented in an application that may be operable using a variety of devices. Non-transitory computer-readable storage media refers to any medium or media that participate in storing and providing instructions to a central processing unit (CPU) for execution. Such media can take many forms, including, but not limited to, non-volatile and volatile media such as optical or magnetic disks and dynamic memory, respectively. The term non-transitory computer-readable storage media does not refer to transitory signals. Common forms of non-transitory computer-readable media include, for example, a FLASH memory/disk, a hard disk, magnetic tape, any other magnetic medium, a CD-ROM disk, digital video disk (DVD), any other optical medium, RAM, PROM, EPROM, a FLASH EPROM, and any other memory chip or cartridge.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

what is claimed is:

1. A system for forming and annealing a thermoplastic article comprising:
an injection nozzle for receiving a melted thermoplastic;
a forming mold with a void in the shape of an article to be formed that receives the melted thermoplastic from the injection nozzle;
a transfer mechanism that moves the formed article; and
an annealing mold that is heated based on heat provided by a heating element, wherein the transfer mechanism moves the article from the forming mold to the annealing mold after the article is formed and the article is annealed based on the heat provided by the heating element.

2. The system of claim 1, further comprising a first fluid reservoir for containing a heated fluid heated by the heated element and connected to the at least one of a fluid inlet and a fluid outlet of the annealing mold.

3. The system of claim 2, further comprising a second fluid reservoir for containing a cool fluid and connected to the at least one of the fluid inlet and the fluid outlet of the annealing mold.

4. The system of claim 1, further comprising a first ejector that ejects the article from the forming mold.

5. The system of claim 4, further comprising a second ejector that ejects the article from the annealing mold.

6. The system of claim 2, further comprising one or more valves that control movement of one or more fluids.

7. The system of claim 1, further comprising:
a memory;
a processor that executes instructions of the memory to control:
a temperature of the melted thermoplastic;
the movement of the formed article; and
the heating of the annealing mold.

8. The system of claim 7, wherein the processor executes additional instructions out of the memory to control a cooling temperature of the annealing mold.

9. A method for forming and annealing a thermoplastic article comprising:
providing a melted thermoplastic material to an injection nozzle of a forming mold, wherein an article is formed based on receipt of the melted thermoplastic material via the injection nozzle;
moving the formed article to with a transfer mechanism to an annealing mold; and
heating the annealing mold when the article is annealed based on the heating of the annealing mold.

10. The method of claim 9, further comprising moving a heated fluid from a first fluid reservoir where the annealing mold is heated based on the heated fluid being moved to the annealing mold.

11. The method of claim 10, further comprising moving a cooled fluid from a second fluid reservoir to cool the annealing mold.

12. The method of claim 9, further comprising initiating operation of a first ejector that ejects the article from the forming mold.

13. The method of claim 12, further comprising initiating operation of a second ejector that ejects the article from the annealing mold.

14. The method of claim 9, further comprising controlling operation of one or more valves to control the movement of one or more fluids.

16. The method of claim 1, further comprising controlling:
a temperature of the melted thermoplastic;
the movement of the formed article; and
the heating of the annealing mold.

17. A non-transitory computer-readable storage medium having embodied thereon a program executable by a processor implementing a method for forming and annealing a thermoplastic article, the method comprising:
providing a melted thermoplastic material to an injection nozzle of a forming mold, wherein an article is formed based on receipt of the melted thermoplastic material via the injection nozzle;
moving the formed article to with a transfer mechanism to an annealing mold; and
heating the annealing mold when the article is annealed based on the heating of the annealing mold.

18. The non-transitory computer-readable storage medium of claim 17, the program further executable to control movement of a first fluid from a first fluid reservoir where the first fluid is heated.

19. The non-transitory computer-readable storage medium of claim 18, the program further executable to control movement of a second fluid from a second fluid reservoir where the second fluid is cooled.

20. The non-transitory computer-readable storage medium of claim 17, the program further executable to initiate operation of a first ejector that ejects the article from the forming mold.
